(19) United States
(12) Patent Application Publication
(10) Pub. No.: US 2025/0146719 A1
(43) Pub. Date: May 8, 2025

(54) REFRIGERANT FLOW RATE ADJUSTMENT DEVICE AND SYSTEM USING THE SAME

(71) Applicants: HYUNDAI MOTOR COMPANY, Seoul (KR); KIA CORPORATION, Seoul (KR)

(72) Inventors: Jae Kwon Lee, Hwaseong-si (KR); Dae Ki Hong, Hwaseong-si (KR); Seok Jin Hong, Hwaseong-si (KR); Ki Hoon Kim, Ansan-si (KR); Jae Woong Kim, Hwaseong-si (KR); Se Kyu Oh, Guri-si (KR)

(73) Assignees: HYUNDAI MOTOR COMPANY, Seoul (KR); KIA CORPORATION, Seoul (KR)

(21) Appl. No.: 18/608,416

(22) Filed: Mar. 18, 2024

(30) Foreign Application Priority Data
Nov. 6, 2023 (KR) 10-2023-0151861

(51) Int. Cl. F25B 41/22

(52) U.S. Cl. CPC F25B 41/22; F25B 2500/28; F25B 2600/2515; F25B 2600/2519; F25B 2700/13; F25B 2700/2117

(57) ABSTRACT

A refrigerant flow rate adjustment device and a system using the same include a refrigerant provided at a quantitative flow rate to a heat exchanger such that the occurrence of a liquid refrigerant is reduced at an outlet end of an evaporator. The refrigerant flow rate adjustment device and system prevent the occurrence of the liquid refrigerant at the outlet end of the heat exchanger, prevent an increase in load, and prevent a lubrication defect of a compressor.

### CROSS-REFERENCE TO RELATED APPLICATION

The present application claims priority to Korean Patent Application No. 10-2023-0151861, filed on Nov. 6, 2023, the entire contents of which are incorporated herein for all purposes by this reference.

### BACKGROUND

### Field of the Disclosure

The present disclosure relates to a refrigerant flow rate adjustment device and to a system using the same, which are capable of preventing an increase in load and a lubrication defect of a compressor.

### Description of the Related Art

In general, a heat pump air conditioner may include a compressor, an internal heat exchanger, an expansion valve, and an external heat exchanger. Additionally, the heat pump air conditioner includes an accumulator and a switching valve configured to switch a flow direction of a refrigerant.

The compressor compresses the refrigerant and discharges the refrigerant in a high-temperature, high-pressure gaseous state.

The internal heat exchanger receives the refrigerant discharged from the compressor and allows the refrigerant to exchange heat with air. In a cooling operation mode, the internal heat exchanger serves as an evaporator that evaporates a refrigerant in a low-temperature and low-pressure liquid state to a refrigerant in a gaseous state. In a heating operation mode, the internal heat exchanger serves as a condenser that condenses a refrigerant in a high-temperature and high-pressure gaseous state to a refrigerant in a room-temperature and high-pressure liquid state. The internal heat exchanger serves to allow the refrigerant to exchange heat with ambient air while coping with a change in enthalpy of the refrigerant.

The expansion valve is connected to the internal heat exchanger or the external heat exchanger and depressurizes the received refrigerant.

The external heat exchanger is positioned outdoors. The external heat exchanger serves as a condenser in the cooling operation mode and serves as an evaporator that exchanges heat with ambient air in the heating operation mode.

As described above, the heat pump system employing phase change uses endothermic and exothermic processes of the refrigerant transitioning from liquid refrigerant to gaseous refrigerant and vice versa. This process enables the system to achieve a temperature of an intended environment.

In this way, in order to perform the phase change from the liquid refrigerant to the gaseous refrigerant, the refrigerant is supplied to the heat exchanger (evaporator), and heat is absorbed. The expansion valve controls the supply flow rate of the refrigerant to be provided to the heat exchanger. The expansion valve adjusts the flow rate by regulating a cross-sectional area of a pipe by using a mechanical or electric phase regulation device.

In particular, an optimal state is a state in which the overall liquid refrigerant is vaporized and no liquid refrigerant is present at an outlet side of the heat exchanger.

Specifically, in a cooling or heat pump system that uses an isothermal and isobaric process of the phase change of the refrigerant for heat exchange, a heat transfer amount is determined depending on the operational capacity of the compressor and the opening degree of the expansion valve.

In this case, the maximum performance of the heat transfer is achieved as the internal pressure of the evaporator decreases, and a maximum heat transfer amount is achieved when the expansion valve is in a maximum open state in the maximum operating region of the compressor.

When a desired heat transfer amount is minimal, the operational output of the compressor decreases, and the opening degree of the expansion valve decreases, such that the mass flow rate of the refrigerant decreases.

In this case, the decrease in output of the compressor may increase the pressure in the evaporator. Additionally, a small heat transfer amount may be achieved. However, when the refrigerant is not supplied at a precise flow rate, the liquid refrigerant may remain at the outlet side of the evaporator. The expansion valve in the related art performs control to increase the cross-sectional area of a flow path such as to increase a mass flow rate. However, because the mass flow rate is supplied in a non-linear manner, the liquid refrigerant may remain at an outlet end of the evaporator.

Therefore, the expansion valve controls the flow rate of the refrigerant and the mechanical or electric phase regulation device controls the mass flow of the liquid refrigerant by controlling the cross-sectional area of the fluid flow path and utilizing orifice flow characteristics.

However, according to the orifice flow characteristics, it is difficult to precisely control the mass flow rate because of complex factors. For this reason, the liquid refrigerant may eventually remain at the outlet end of the heat exchanger, which may increase the load of a refrigerant compression pump and cause scuffing on a lubrication surface caused by a lubrication defect.

The foregoing explained as the background is intended merely to aid in understanding the background of the present disclosure. Therefore, the foregoing is not intended to mean that the present disclosure falls within the purview of the related art that is already known to those having ordinary skill in the art.

### SUMMARY

The present disclosure is provided to solve the above mentioned problems and aims to provide a refrigerant flow rate adjustment device and a system using the same. The refrigerant flow rate adjustment device and system are capable of preventing an increase in load and a lubrication defect of a compressor by reducing the occurrence of liquid refrigerant at an outlet end of an evaporator. This is achieved by controlling a flow rate of the refrigerant to be provided to the evaporator.

In order to achieve the above-mentioned objects, a refrigerant flow rate adjustment device according to the present disclosure is provided. The device includes a cylinder part having an internal space and having an inlet portion and an outlet portion and includes an on-off valve provided in the inlet portion of the cylinder part and configured to open or close the inlet portion. The device also includes a flow rate adjuster configured to move linearly in the internal space of the cylinder part. The flow rate adjuster includes a piston portion configured to move in the internal space, and a valve portion configured to open or close the outlet portion. A fluid is stored in a volume of the internal space of the cylinder part and then quantitatively discharged through the outlet portion by an opening/closing operation of the on-off valve and a movement of the flow rate adjuster.

The inlet portion and the outlet portion of the cylinder part may be disposed in an orthogonal direction to each other. The inlet portion may be disposed adjacent to the outlet portion in the internal space.

The outlet portion of the cylinder part may be formed such that an inlet, which is adjacent to the internal space, and an outlet, which is opposite to the inlet, have cross-sectional areas that gradually increase in a direction opposite to a direction in which the inlet and the outlet face each other.

The valve portion of the flow rate adjuster may be provided at a side adjacent to the outlet of the outlet portion and formed to match a shape of the outlet. The valve portion may be formed to be smaller in diameter than the outlet portion.

The piston portion and the valve portion of the flow rate adjuster may be disposed to be spaced apart from each other. The valve portion may be configured to close the outlet portion when the piston portion is positioned at a maximum distance from the outlet portion in the internal space. The valve portion may be configured to open the outlet portion when the piston portion moves toward the outlet portion.

The refrigerant flow rate adjustment device may further include a controller configured to control the on-off valve and the flow rate adjuster. The controller may be configured to control the flow rate adjuster to close the outlet portion of the cylinder part when the on-off valve is controlled to be opened, such that the internal space is filled with the fluid. The controller may also be configured to control the flow rate adjuster so that the piston portion of the flow rate adjuster pressurizes the fluid and the valve portion of the flow rate adjuster opens the outlet portion when the on-off valve is controlled to be closed. This is achieved so that the fluid in the internal space is quantitatively discharged.

The controller may also be configured to control the flow rate adjuster so that the movement of the flow rate adjuster according to an opening/closing timing of the on-off valve is repeatedly operated in the same cycle.

A refrigerant flow rate adjustment system according to the present disclosure includes: a heat exchanger having a refrigerant inflow line and a refrigerant outflow line; a refrigerant flow rate adjustment device installed in the refrigerant inflow line and configured to quantitatively provide a refrigerant to the heat exchanger; and a controller configured to control the flow rate adjustment device. The refrigerant flow rate adjustment device includes a cylinder part having an internal space, an inlet portion, and an outlet portion. The device also includes an on-off valve provided in the inlet portion and configured to open or close the inlet portion. The device also includes a flow rate adjuster configured to move linearly in the internal space of the cylinder part. The flow rate adjuster also includes a piston portion configured to move in the internal space and a valve portion configured to open or close the outlet portion in accordance with a movement of the flow rate adjuster.

The controller may be configured to store, as one control cycle, a process in which the on-off valve is opened and the flow rate adjuster closes the outlet portion of the cylinder part so that the internal space is filled with the fluid. Additionally, the control cycle may include a process in which the on-off valve is closed, the piston portion of the flow rate adjuster pressurizes the fluid, and the valve portion opens the outlet portion.

The controller may be configured to receive information on a temperature of the heat exchanger and an output of a compressor. The controller may also be configured to store in advance an expected temperature according to the output of the compressor and the specifications of the heat exchanger. The controller may also be configured to derive an optimal value of a refrigerant flow rate by determining and comparing the expected temperature and the temperature of the heat exchanger under a current operating condition of the compressor.

The controller may be configured to adjust an output of the compressor or a control cycle of the flow rate adjustment device based on the optimal value of the refrigerant flow rate.

An accumulator may be provided in the refrigerant inflow line and disposed at a front end of the refrigerant flow rate adjustment device.

According to the refrigerant flow rate adjustment device and the system using the same structure as described above, the refrigerant is provided at a quantitative flow rate to the heat exchanger. Thus, the occurrence of the liquid refrigerant is reduced at the outlet end of the evaporator. As a result, the refrigerant flow rate adjustment device and system prevent the occurrence of the liquid refrigerant at the outlet end of the heat exchanger, prevent an increase in load, and prevent a lubrication defect of the compressor.

### BRIEF DESCRIPTION OF THE DRAWINGS

FIG. 1 is a view illustrating a refrigerant flow rate adjustment system according to an embodiment of the present disclosure.

FIG. 2 is a view illustrating a refrigerant flow rate adjustment device according to the present disclosure.

FIG. 3 is a view illustrating a state in which a refrigerant flow rate adjustment device according to the present disclosure is connected to a heat exchanger.

FIG. 4 is a view illustrating a state in which a fluid is introduced into the refrigerant flow rate adjustment device illustrated in FIG. 2.

FIG. 5 is a view illustrating a state in which the refrigerant flow rate adjustment device illustrated in FIG. 2 pressurizes the fluid.

FIG. 6 is a view illustrating a state in which the fluid is discharged from the refrigerant flow rate adjustment device illustrated in FIG. 2.

FIG. 7 is a view illustrating a refrigerant flow rate adjustment system according to another embodiment of the present disclosure.

### DETAILED DESCRIPTION

Hereinafter, embodiments disclosed in the present disclosure are described in detail with reference to the accompanying drawings. The same or similar constituent elements are assigned with the same reference numerals regardless of reference numerals, and the repetitive description thereof have been omitted.

The suffixes “module,” “unit,” “part,” and “portion” used to describe constituent elements in the following description are used together or interchangeably in order to facilitate the description, but the suffixes themselves do not have distinguishable meanings or functions.

In the description of the embodiments disclosed in the present disclosure, the specific descriptions of publicly known related technologies have been omitted where it has been determined that the specific descriptions may obscure the subject matter of the embodiments disclosed in the present disclosure. In addition, it should be interpreted that the accompanying drawings are provided only to allow those having ordinary skill in the art to easily understand the embodiments disclosed in the present disclosure. Additionally, the technical spirit disclosed in the present disclosure is not limited by the accompanying drawings, and includes all alterations, equivalents, and alternatives that are included in the spirit and the technical scope of the present disclosure.

The terms including ordinal numbers such as “first,” “second,” and the like may be used to describe various constituent elements, but the constituent elements are not limited by the terms. These terms are used only to distinguish one constituent element from another constituent element.

When one constituent element is described as being “coupled” or “connected” to another constituent element, it should be understood that one constituent element can be coupled or connected directly to another constituent element, and an intervening constituent element can also be present between the constituent elements. When one constituent element is described as being “coupled directly to” or “connected directly to” another constituent element, it should be understood that no intervening constituent element is present between the constituent elements.

Singular expressions include plural expressions unless clearly described as having different meanings in the context.

In the present disclosure, it should be understood that the terms “comprises,” “comprising,” “includes,” “including,” “containing,” “has,” “having” or other variations thereof are inclusive and therefore specify the presence of stated features, integers, steps, operations, elements, components, or combinations thereof. However, the terms do not preclude the presence or addition of one or more other features, integers, steps, operations, elements, components, or combinations thereof.

A controller may include a communication device configured to communicate with another control unit or a sensor to control a corresponding function, a memory configured to store an operating system, a logic instruction, and input/output information, and one or more processors configured to perform determination, computation, decision, or the like required to control the corresponding function.

When a controller, component, device, element, part, unit, module, or the like of the present disclosure is described as having a purpose or performing an operation, function, or the like, the controller, component, device, element, part, unit, or module should be considered herein as being “configured to” meet that purpose or perform that operation or function. Each controller, component, device, element, part, unit, module, and the like may separately embody or be included with a processor and a memory, such as a non-transitory computer-readable media, as part of the apparatus.

Hereinafter, a refrigerant flow rate adjustment device and a system using the same, according to embodiments of the present disclosure, are described with reference the accompanying drawings.

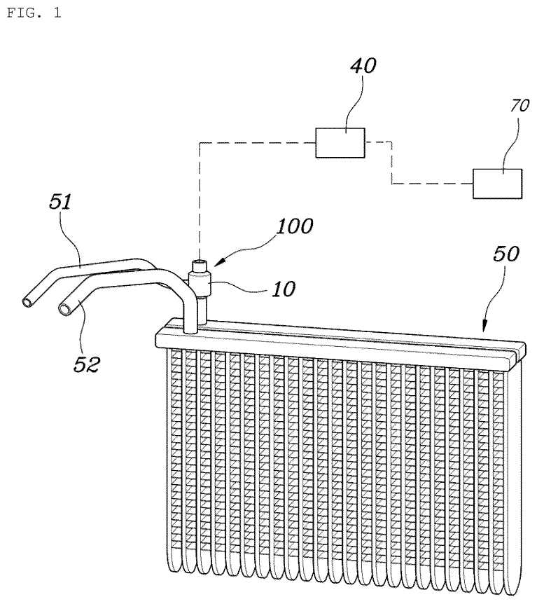

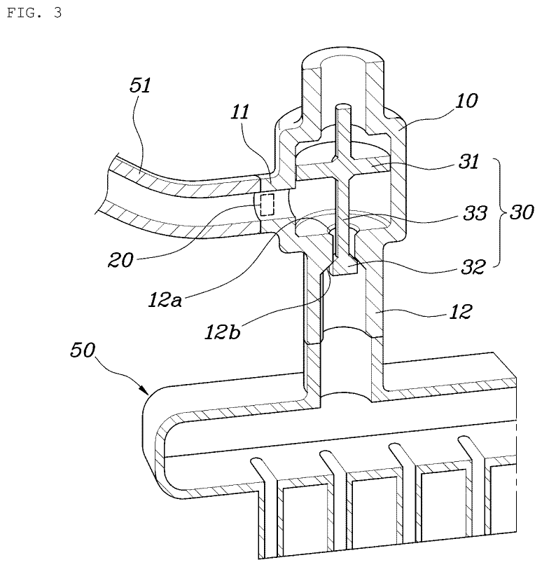

As illustrated in FIGS. 1-3, a refrigerant flow rate adjustment device (i.e., the device) according to the present disclosure includes a cylinder part 10 having an internal space. The cylinder part 10 includes an inlet portion 11 and an outlet portion 12. The device also includes an on-off valve 20 provided in the inlet portion 11 of the cylinder part 10. The on-off valve is configured to open or close the inlet portion 11. The device also includes a flow rate adjuster 30 that is configured to move linearly (e.g., straight or in a single direction) in the internal space of the cylinder part 10. The flow rate adjuster 30 includes a piston portion 31 configured to move in the internal space and a valve portion 32 configured to open or close the outlet portion 12. The cylinder part 10 is filled with a fluid in a volume of the internal space and then the fluid is quantitatively discharged through the outlet portion 12 by the opening/closing operation of the on-off valve 20 and the movement of the flow rate adjuster 30.

The cylinder part 10 may be provided at a front end of an evaporator (i.e., a heat exchanger 50). The fluid passing through the cylinder part 10 may be a refrigerant.

The on-off valve 20 may be provided in the inlet portion 11 of the cylinder part 10 or spaced apart from the inlet portion 11 and installed in a refrigerant line. However, the on-off valve 20 may be installed in the inlet portion 11 of the cylinder part 10 so that a predetermined amount of fluid is introduced into the internal space of the cylinder part 10 when the on-off valve 20 is opened.

The on-off valve 20 may be configured as an electronic valve and opened or closed under the control of a controller 40. The on-off valve 20 may be configured such that an opening degree thereof is adjusted, and the opened or closed state is selectively switched.

The flow rate adjuster 30 is configured to move linearly in the internal space of the cylinder part 10. The flow rate adjuster 30 may be configured as a solenoid and configured to move linearly in the internal space of the cylinder part 10 (i.e., perform the motion) under the control of the controller 40. Alternatively, the flow rate adjuster 30 may be configured as a piezoelectric element and move linearly (e.g., in one direction) in the internal space depending on the pressure of the fluid stored in the internal space.

The flow rate adjuster 30 includes the piston portion 31 and the valve portion 32. The piston portion 31 and the valve portion 32 may be integrally manufactured. Alternatively, the piston portion 31 and the valve portion 32 may be separately manufactured and then coupled to each other.

The piston portion 31 may move in the internal space of the cylinder part 10 such that the piston portion 31 may be positioned so that the internal space is filled with fluid. Alternatively, the piston portion 31 may move in the internal space of the cylinder part 10 such that the piston portion 31 may be positioned so that the fluid stored in the internal space is pressurized and discharged to the outside.

The valve portion 32 moves together with the piston portion 31. The outlet portion 12 of the cylinder part 10 is opened or closed depending on the movement position of the valve portion 32. In this case, the fluid may be adiabatically expanded and atomized in a low-temperature and low-pressure state by a throttling operation and sprayed (e.g., provided) to the evaporator (i.e., the heat exchanger 50).

Therefore, in the present disclosure, as the on-off valve 20 is opened, the internal space of the cylinder part 10 is filled with fluid. As the flow rate adjuster 30 moves, the cylinder part 10 pressurizes the fluid in the internal space. At the same time, the valve portion 32 is opened, such that the fluid in the internal space is discharged through the outlet portion 12 of the cylinder part 10.

Therefore, in the present disclosure, the fluid, which is stored in the volume of the internal space of the cylinder part 10, is quantitatively discharged. As a result, the fluid is precisely supplied at a quantitative flow rate, which reduces the occurrence of the fluid (i.e., a liquid refrigerant) at an outlet end of the heat exchanger 50. Therefore, an increase in the load of the compressor 70 and scuffing caused by a lubrication defect are prevented.

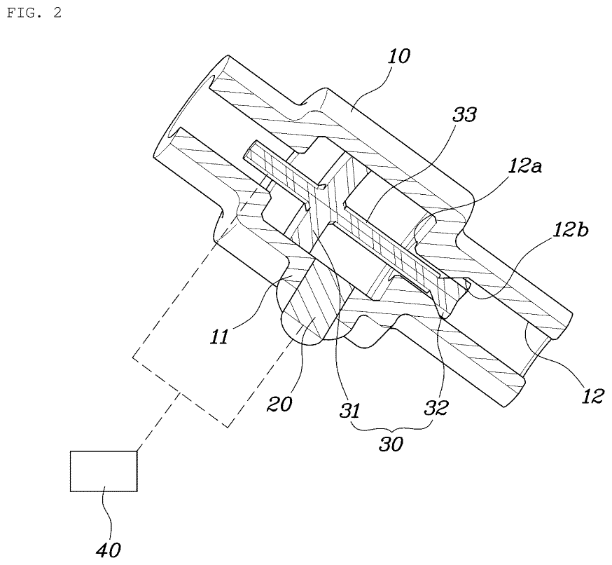

As illustrated in FIG. 2, the inlet portion 11 and the outlet portion 12 of the cylinder part 10 are disposed in an orthogonal direction to each other. The inlet portion 11 may be disposed in the internal space and adjacent to the outlet portion 12.

As described above, because the cylinder part 10 is configured such that the inlet portion 11, into which the fluid is introduced, and the outlet portion 12, from which the fluid is discharged, are disposed orthogonally in the internal space, the fluid (i.e., the refrigerant) introduced through the inlet portion 11 may flow to the outlet portion 12 in the internal space without interfering with the piston portion 31 of the flow rate adjuster 30.

In addition, because the inlet portion 11 and the outlet portion 12 are disposed to be adjacent to each other in the internal space, it is easy to ensure the amount of fluid that fills the internal space when the piston portion 31 moves.

The outlet portion 12 of the cylinder part 10 may be formed such that an inlet 12a, which is adjacent to the internal space, and an outlet 12b, which is opposite to the inlet 12a, have cross-sectional areas that gradually increase in a direction opposite to a direction in which the inlet 12a and the outlet 12b face each other.

Therefore, the flow of the fluid, which is to be discharged to the outside through the outlet portion 12 from the internal space of the cylinder part 10, is accelerated by a shape of the inlet 12a of the outlet portion 12. Additionally, the fluid is atomized and sprayed due to the shape of the outlet 12b of the outlet portion 12 such that the fluid may be discharged in a liquid droplet state.

In this case, the flow rate adjuster 30 has a connection portion 33 provided between the piston portion 31 and the valve portion 32. The connection portion 33 penetrates the outlet portion 12 of the cylinder part 10. A diameter of the connection portion 33 is smaller than the diameter of the outlet portion 12 such that the fluid may flow through the outlet portion 12.

In addition, the valve portion 32 of the flow rate adjuster 30 is provided at a side adjacent to the outlet 12b of the outlet portion 12 and formed to match the shape of the outlet 12b. The valve portion 32 may be formed to be smaller in diameter than a portion of the outlet portion 12.

When the valve portion 32 of the flow rate adjuster 30 is provided at the side adjacent to the outlet 12b of the outlet portion 12 as described above, the valve portion 32 closes the outlet portion 12 by coming into contact with the outlet portion 12. Alternatively, the valve portion 32 opens the outlet portion 12 by moving away from the outlet portion 12 in accordance with the movement of the flow rate adjuster 30.

The valve portion 32 may be formed to match the shape of the outlet 12b of the outlet portion 12. In other words, in the present disclosure, because the outlet 12b of the outlet portion 12 is formed such that a cross-sectional area thereof gradually increases, the valve portion 32 may be formed such that a cross-sectional area thereof gradually decreases with respect to the outlet portion 12. Therefore, the sealing performance may be ensured by the matched or cooperating shapes of the valve portion 32 and the outlet 12b when the valve portion 32 of the flow rate adjuster 30 comes into contact with the outlet 12b of the outlet portion 12.

The piston portion 31 and the valve portion 32 of the flow rate adjuster 30 may be formed to be spaced apart from each other. Therefore, the valve portion 32 may close the outlet portion 12 when the piston portion 31 is positioned at a maximum distance from the outlet portion 12 in the internal space. Furthermore, the valve portion 32 may open the outlet portion 12 when the piston portion 31 moves toward the outlet portion 12.

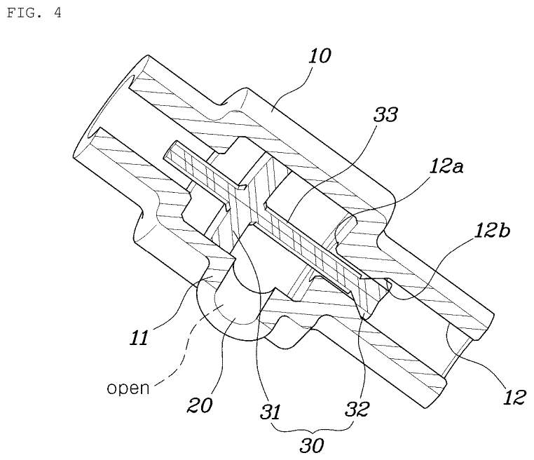

As can be seen in FIG. 4, the piston portion 31 and the valve portion 32 of the flow rate adjuster 30 are connected by the connection portion 33 and formed to be spaced apart from each other.

In this case, a distance between the piston portion 31 and the valve portion 32 may be set based on the valve portion 32 being positioned to close the outlet portion 12 when the piston portion 31 is positioned at the maximum distance from the outlet portion 12 in the internal space.

Therefore, when the piston portion 31 is disposed in the internal space so as to be maximally spaced apart from the outlet portion 12 in accordance with the movement of the flow rate adjuster 30, the valve portion 32 closes the outlet portion 12 of the cylinder part 10. As a result, the internal space of the cylinder part 10 may be filled with the fluid.

In this case, when the flow rate adjuster 30 moves toward the outlet portion 12, the piston portion 31 pressurizes the fluid stored in the internal space. Consequently, the valve portion 32 moves away from the outlet portion 12 and opens the outlet portion 12. As a result, the fluid may be discharged through the outlet portion 12.

The on-off valve 20 and the flow rate adjuster 30 are controlled by the controller 40.

In other words, when the controller 40 controls and opens the on-off valve 20, the flow rate adjuster 30 closes the outlet portion 12 of the cylinder part 10, such that the internal space is filled with the fluid. When the controller 40 controls and closes the on-off valve 20, the piston portion 31 of the flow rate adjuster 30 pressurizes the fluid, and the valve portion 32 opens the outlet portion 12, such that the fluid in the internal space may be quantitatively discharged.

Specifically, as illustrated in FIG. 4, the flow rate adjuster 30 moves in a direction in which a volume of the internal space of the cylinder part 10 increases, and the on-off valve 20 is opened. As a result, the fluid (i.e., the refrigerant) is introduced into the internal space through the inlet 12a of the cylinder part 10.

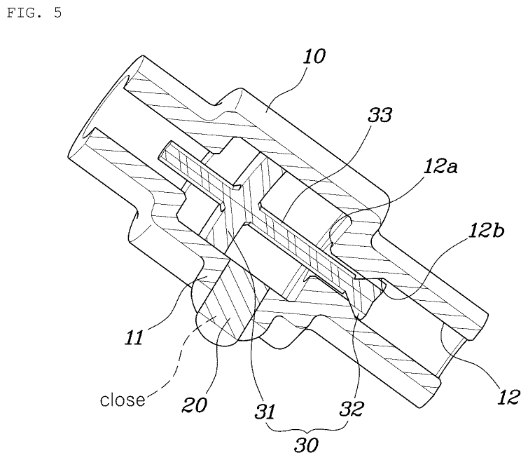

When the internal space of the cylinder part 10 is filled with the fluid, the on-off valve 20 is closed, as illustrated in FIG. 5.

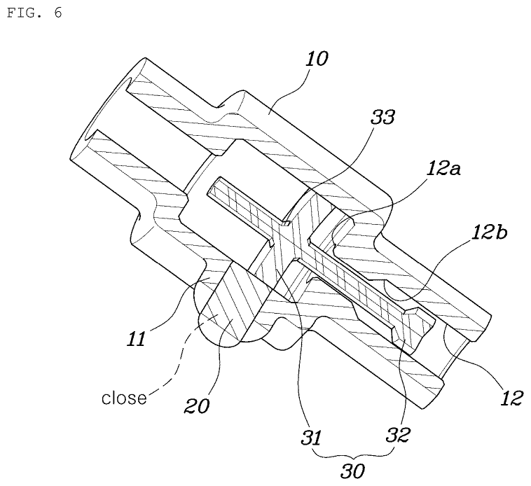

Thereafter, as illustrated in FIG. 6, the flow rate adjuster 30 moves in the direction in which the volume of the internal space of the cylinder part 10 decreases. Therefore, the valve portion 32 of the flow rate adjuster 30 pressurizes the fluid in the internal space, and the valve portion 32 opens the outlet portion 12. As a result, the fluid is discharged through the outlet portion 12.

In this case, the movement of the flow rate adjuster 30 may be changed under the control of the controller 40. When the flow rate adjuster 30 has a piezoelectric structure, the movement of the flow rate adjuster 30 may be changed by the pressure in the internal space.

The controller 40 may store, as one cycle, the movement of the flow rate adjuster 30 according to an opening/closing timing of the on-off valve 20 and repeat the corresponding cycle in the same way so that the fluid stored in the internal space is supplied at a quantitative flow rate by the flow rate adjuster 30.

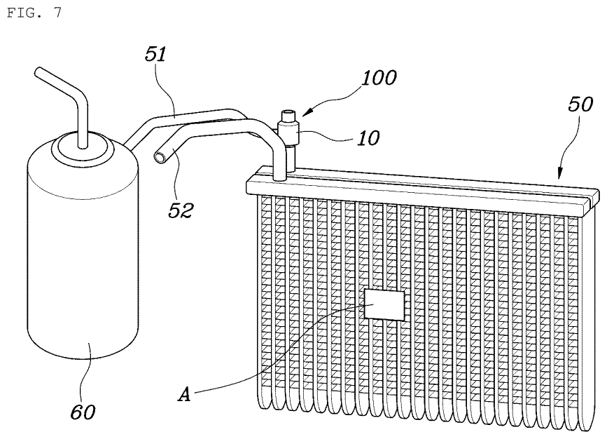

As illustrated in FIGS. 1 and 7, a refrigerant flow rate adjustment system according to the present disclosure includes the heat exchanger 50 having a refrigerant inflow line 51 and a refrigerant outflow line 52 and includes a refrigerant flow rate adjustment device 100 installed in the refrigerant inflow line 51. The refrigerant flow rate adjustment device 100 is configured to quantitatively provide the refrigerant to the heat exchanger 50. The refrigerant flow rate adjustment system further includes the controller 40 configured to control the flow rate adjustment device 100.

The heat exchanger 50 may be configured as an evaporator, and the refrigerant may circulate through the refrigerant inflow line 51 and the refrigerant outflow line 52.

The refrigerant flow rate adjustment device 100 is installed in the refrigerant inflow line 51 and provides the refrigerant, which flows through the heat exchanger 50, at a quantitative flow rate.

The refrigerant flow rate adjustment device 100 may include the cylinder part 10 having the internal space and including the inlet portion 11 and the outlet portion 12. The device may also include the on-off valve 20 provided in the inlet portion 11 of the cylinder part and configured to open or close the inlet portion 11. The device may also include the flow rate adjuster 30 configured to move linearly in the internal space of the cylinder part 10. The flow rate adjuster includes the piston portion 31 configured to move in the internal space, and the valve portion 32 configured to open or close the outlet portion 12 in accordance with the movement position.

As described above, the refrigerant flow rate adjustment device 100 may include the cylinder part 10, the on-off valve 20, and the flow rate adjuster 30. The on-off valve 20 may be provided in the inlet port 12a of the cylinder part 10, and the valve portion 32 of the flow rate adjuster 30 may be provided in the outlet portion 12.

In particular, the flow rate adjuster 30 is configured to move linearly in the internal space of the cylinder part 10. The flow rate adjuster 30 may be configured as a solenoid and move under the control of the controller 40. Alternatively, the flow rate adjuster 30 may be configured as a piezoelectric element and move in the internal space of the cylinder part 10 depending on the pressure of the fluid stored in the internal space.

The flow rate adjuster 30 includes the piston portion 31 and the valve portion 32. The piston portion 31 may move in the internal space of the cylinder part 10. As a result, the piston portion 31 may be positioned so that the internal space is filled with the fluid or positioned so that the fluid stored in the internal space is pressurized and discharged to the outside.

The valve portion 32 moves together with the piston portion 31. The outlet portion 12 of the cylinder part 10 is opened or closed depending on the movement and position of the valve portion 32. In this case, the refrigerant may be adiabatically expanded and atomized in a low-temperature and low-pressure state by a throttling operation and sprayed (i.e., provided) to the heat exchanger 50.

The refrigerant flow rate adjustment device 100 is controlled by the controller 40 such that the opening/closing of the on-off valve 20 and the position and movement of the flow rate adjuster 30 are adjusted.

The controller 40 may store, as one control cycle, the process in which the on-off valve 20 is opened while the flow rate adjuster 30 closes the outlet portion 12 of the cylinder part 10 so that the internal space is filled with fluid. Additionally, the cycle may include a process in which the on-off valve 20 is closed while the piston portion 31 of the flow rate adjuster 30 pressurizes the fluid and the valve portion 32 opens the outlet portion 12.

Therefore, the fluid, which is stored in the volume of the internal space of the cylinder part 10, is quantitatively provided to the heat exchanger 50, such that the refrigerant is precisely supplied at a flow rate, which reduces the occurrence of the liquid refrigerant at the outlet end of the heat exchanger 50. Therefore, an increase in load of the compressor 70 and scuffing caused by a lubrication defect are prevented.

Specifically, the controller 40 moves the flow rate adjuster 30 in the direction in which the volume of the internal space of the cylinder part 10 increases, and the on-off valve 20 is opened, such that the refrigerant is introduced into the internal space through the inlet 12a of the cylinder part 10.

When the internal space of the cylinder part 10 is filled with fluid as described above, the on-off valve 20 is closed, and the flow rate adjuster 30 moves in the direction in which the volume of the internal space of the cylinder part 10 decreases. Therefore, the piston portion 31 of the flow rate adjuster 30 pressurizes the fluid in the internal space, and the valve portion 32 opens the outlet portion 12, such that the fluid is discharged through the outlet portion 12.

In this case, the discharged fluid (i.e., liquid refrigerant) is atomized and sprayed, supplied in a droplet state to the heat exchanger 50, and phase changed to the gaseous state.

As the controller 40 repeatedly controls the on-off valve 20 and the flow rate adjuster 30 as described above, the fluid (i.e., liquid refrigerant) may be quantitatively supplied by the volume determined when the piston portion 31 moves in the internal space of the cylinder part 10. Therefore, the fluid (i.e., liquid refrigerant) is not created at a distal end of the heat exchanger 50 (i.e., the evaporator), which may optimize the circulation of the fluid.

The controller 40 receives information on a temperature of the heat exchanger 50 and an output of the compressor 70 and stores in advance an expected temperature according to the output of the compressor 70 and the specifications of the heat exchanger 50. The controller 40 may derive an optimal value of the refrigerant flow rate by determining and comparing the temperature of the heat exchanger 50 and the expected temperature under a current operation condition of the compressor 70.

The heat exchanger 50 may have a temperature sensor A. The controller 40 may receive information on the temperature of the heat exchanger 50 from the temperature sensor A.

In addition, the controller identify the information on the output of the compressor 70 by controlling the compressor.

In particular, the controller 40 stores in advance the expected temperature according to the output of the compressor 70 and the specifications of the heat exchanger 50. The expected temperature is data determined by performing experiments on the temperature of the heat exchanger 50 according to the specifications such as the output condition of the compressor 70 and the volume of the heat exchanger 50. The expected temperature is stored in advance in the controller 40.

Therefore, the controller 40 derives the refrigerant flow rate at which the refrigerant needs to be supplied to the heat exchanger 50 by determining and comparing the expected temperature and the current temperature of the heat exchanger 50 inputted by the temperature sensor A under the current operating condition of the compressor 70. The refrigerant flow rate, which is derived by the controller 40 as described above, may be an optimal value of the refrigerant flow rate (i.e., a control value of the refrigerant flow rate adjustment device 100). In other words, the controller 40 adjusts the opening/closing timing of the on-off valve 20 and a movement speed of the flow rate adjuster 30 based on the optimal value of the refrigerant flow rate.

Therefore, the controller 40 may adjust the output of the compressor or the control cycle of the flow rate adjustment device based on the optimal value of the refrigerant flow rate.

In other words, when the optimal value of the refrigerant flow rate is derived, the controller 40 may adjust the circulation amount of the refrigerant by adjusting the output amount of the compressor or control the operation of the on-off valve 20 and the flow rate adjuster 30 of the refrigerant flow rate adjustment device 100. Therefore, when the refrigerant is provided to the evaporator in accordance with the optimal value of the refrigerant flow rate, the quantitative optimized refrigerant may be supplied.

An accumulator 60 may be further provided in the refrigerant inflow line 51 and disposed at a front end of the refrigerant flow rate adjustment device 100.

The refrigerant flow rate adjustment system includes the accumulator 60 as described above, such that impact pressure of the refrigerant supplied to the refrigerant flow rate adjustment device 100 may be prevented. As a result, the refrigerant with predetermined pressure may be provided. Therefore, the accumulator 60 of the refrigerant flow rate adjustment system amount of refrigerant with receives the predetermined predetermined pressure, thereby supplying the optimized quantitative refrigerant to the heat exchanger 50.

According to the refrigerant flow rate adjustment device and system using the same structure as described above, the refrigerant is provided at a quantitative flow rate to the heat exchanger 50, such that the occurrence of the liquid refrigerant is reduced at the outlet end of the evaporator. As a result, the refrigerant flow rate adjustment device and system prevent the occurrence of the liquid refrigerant at the outlet end of the heat exchanger 50, prevent an increase in load, and prevent a lubrication defect of the compressor.

While the specific embodiments of the present disclosure have been illustrated and described, it should be apparent to those having ordinary skill in the art that the present disclosure may be variously modified and changed without departing from the technical spirit of the present disclosure defined in the appended claims.

What is claimed is:

1. A refrigerant flow rate adjustment device comprising:
a cylinder part having an internal space, an inlet portion, and an outlet portion;
an on-off valve provided in the inlet portion of the cylinder part and configured to open or close the inlet portion; and
a flow rate adjuster configured to move linearly in the internal space of the cylinder part, the flow rate adjuster including a piston portion configured to move in the internal space and a valve portion configured to open or close the outlet portion of the cylinder part,
wherein a fluid is stored in a volume of the internal space of the cylinder part and then quantitatively discharged through the outlet portion by an opening/closing operation of the on-off valve and a movement of the flow rate adjuster.

2. The refrigerant flow rate adjustment device of claim 1, wherein the inlet portion and the outlet portion of the cylinder part are disposed in an orthogonal direction relative to each other, and wherein the inlet portion is disposed adjacent to the outlet portion in the internal space.

3. The refrigerant flow rate adjustment device of claim 1, wherein the outlet portion of the cylinder part is configured such that an inlet, which is adjacent to the internal space, and an outlet, which is opposite to the inlet, have cross-sectional areas that gradually increase in a direction opposite to a direction in which the inlet and the outlet face each other.

4. The refrigerant flow rate adjustment device of claim 3, wherein the valve portion of the flow rate adjuster is provided at a side adjacent to the outlet of the outlet portion and has a shape matching a shape of the outlet, and wherein the valve portion is smaller in diameter than the outlet portion.

5. The refrigerant flow rate adjustment device of claim 1, wherein:
the piston portion and the valve portion of the flow rate adjuster are disposed to be spaced apart from each other;
the valve portion is configured to close the outlet portion when the piston portion is positioned at a maximum distance from the outlet portion in the internal space; and
the valve portion is configured to open the outlet portion when the piston portion moves toward the outlet portion.

6. The refrigerant flow rate adjustment device of claim 1, further comprising:
a controller configured to control the on-off valve and the flow rate adjuster,
wherein the controller is configured to control the flow rate adjuster to close the outlet portion of the cylinder part when the on-off valve is controlled to be opened such that the internal space is filled with the fluid, and
wherein the controller is configured to control the flow rate adjuster so that the piston portion of the flow rate adjuster pressurizes the fluid and the valve portion of the flow rate adjuster opens the outlet portion when the on-off valve is controlled to be closed such that the fluid in the internal space is quantitatively discharged.

7. The refrigerant flow rate adjustment device of claim 6, wherein the controller is configured to control the flow rate adjuster so that the flow rate adjuster, according to an opening/closing timing of the on-off valve, is repeatedly operated in the same cycle.

8. A refrigerant flow rate adjustment system comprising:
a heat exchanger having a refrigerant inflow line and a refrigerant outflow line;
a refrigerant flow rate adjustment device installed in the refrigerant inflow line and configured to quantitatively provide a refrigerant to the heat exchanger; and
a controller configured to control the flow rate adjustment device,
wherein the refrigerant flow rate adjustment device includes
a cylinder part having an internal space, an inlet portion, and an outlet portion,
an on-off valve provided in the inlet portion of the cylinder part and configured to open or close the inlet portion, and
a flow rate adjuster configured to move linearly in the internal space of the cylinder part, the flow rate adjuster including a piston portion configured to move in the internal space and a valve portion configured to open or close the outlet portion in accordance with a movement of the flow rate adjuster.

9. The refrigerant flow rate adjustment system of claim 8, wherein the controller is configured to store, as one control cycle:
a process in which the on-off valve is opened and the flow rate adjuster closes the outlet portion of the cylinder part so that the internal space is filled with a fluid; and
a process in which the on-off valve is closed, the piston portion of the flow rate adjuster pressurizes the fluid, and the valve portion opens the outlet portion.

10. The refrigerant flow rate adjustment system of claim 8, wherein:
the controller is configured to receive information on a temperature of the heat exchanger and an output of a compressor;
the controller is configured to store in advance an expected temperature according to the output of the compressor and specifications of the heat exchanger; and
the controller is configured to derive an optimal value of a refrigerant flow rate by determining and comparing the expected temperature and the temperature of the heat exchanger under a current operating condition of the compressor.

11. The refrigerant flow rate adjustment system of claim 10, wherein the controller is configured to adjust an output of the compressor or a control cycle of the flow rate adjustment device based on the optimal value of the refrigerant flow rate.

12. The refrigerant flow rate adjustment system of claim 8, further comprising an accumulator configured to prevent an impact pressure of the refrigerant supplied to the refrigerant flow rate adjustment device.

13. The refrigerant flow rate adjustment system of claim 12, wherein the accumulator is provided in the refrigerant inflow line and disposed at a front end of the refrigerant flow rate adjustment device.
